(19) United States
(12) Patent Application Publication
(10) Pub. No.: US 2015/0043411 A1
(43) Pub. Date: Feb. 12, 2015

(54) GATEWAY SYSTEM FOR SENSOR NETWORK AND DRIVING METHOD THEREOF

(71) Applicant: Electronics and Telecommunications Research Institute, Daejeon (KR)

(72) Inventors: Bong Wan KIM, Daejeon (KR); Hyun-Joong KANG, Jinju-si (KR); Jun Wook LEE, Cheongju-si (KR); Sungsoo KANG, Daejeon (KR); Hyochan BANG, Daejeon (KR)

(73) Assignee: Electronics and Telecommunications Research Institute, Daejeon (KR)

(21) Appl. No.: 14/457,361

(22) Filed: Aug. 12, 2014

(30) Foreign Application Priority Data
Aug. 12, 2013 (KR) 10-2013-0095618

(51) Int. Cl. H04W 52/02; H04W 4/00; H04W 88/16

(52) U.S. Cl. CPC H04W 52/0206; H04W 88/16; H04W 4/005
USPC 370/311

(57) ABSTRACT

A gateway system for a sensor network and a driving method thereof are disclosed. The gateway system includes a sink node board that collects sensor data measured by a sensor node and transmits the sensor data, and a gateway board that transmits the sensor data transmitted from the sink node board to a server. Herein, the sink node board controls whether to apply power to the gateway board or not.

### CROSS-REFERENCE TO RELATED APPLICATION

This application claims priority to and the benefit of Korean Patent Application No. 10-2013-0095618 filed in the Korean Intellectual Property Office on Aug. 12, 2013, the entire contents of which are incorporated herein by reference.

### BACKGROUND OF THE INVENTION

(a) Field of the Invention

The present invention relates to a gateway system for a sensor network and a driving method thereof.

(b) Description of the Related Art

A sensor network is a technology for collecting various kinds of sensor information over a network through sensor nodes installed in a variety of environments.

As a way to supply power to a gateway for the sensor network, a gateway communicating with the outside is installed in places where constant power supply is available, and power is supplied to the gateway through the constant power supply from socket outlet. However, this method has restrictions on the installation position because the sensor network does not run in places where constant power supply is not available.

To eliminate the restrictions on the installation position, a gateway equipped with self-powered equipment such as solar cells can be installed in places where constant power supply is not available, and power is supplied to the gateway through the self-powered equipment. While this method enables the installation of a gateway even in places where constant power supply is not available, it requires installing self-powered equipment (e.g., power generators using new and renewable energy such as sunlight, wind power, or tidal power) due to high power consumption of the gateway.

To solve this problem, power consumption can be lowered by low-power hardware design of the gateway, which, however, requires low-power operation by using software for the gateway. That is, the power consumption of the gateway can be reduced by a software method to control the idle time of a network interface for communication. However, there are limitations in reducing power consumption as long as the software for the gateway runs continuously.

### SUMMARY OF THE INVENTION

The present invention has been made in an effort to provide a gateway system which reduces power consumption in a sensor network, and a driving method thereof.

An exemplary embodiment of the present invention provides a gateway system. The gateway system may include: a sink node board that collects sensor data measured by a sensor node and transmits the sensor data; and a gateway board that transmits the sensor data transmitted from the sink node board to a server, wherein the sink node board may control whether to apply power to the gateway board or not.

The sink node board may calculate how much spare power there is to drive the gateway board, and determine whether to apply power or not depending on the amount of spare power.

The gateway system may further include: self-powered equipment that is connected to the sink node board and that is able to produce electricity on its own without external constant power supply; and a rechargeable battery that is connected to the sink node board and stores the electricity produced by the self-powered equipment, wherein the sink node board may calculate the amount of spare power based on the amount of charge in the rechargeable battery, the electric power production of the self-powered equipment, and the power consumption of the sink node board.

If the power consumption of the gateway board is less than a value obtained by subtracting the power consumption of the sink node board from the electric power production of the self-powered equipment, the sink node board may determine that there is sufficient spare power and apply power to the gateway board.

If the sink node board applies power to the gateway board, the sink node board may transmit the sensor data to the gateway board.

Upon receiving the sensor data from the sink node board, the gateway board may send a request for an extension of the driving time of the gateway board to the sink node board, and upon receiving acceptance of the extension of the driving time from the sink node board, may transmit the sensor data to the server.

The sink node board may include a power-off switch for switching the power on or off.

The gateway board may include a GPS module that acquires the gateway board's position information and current time information, and the gateway board may transmit the position information to the server and the current time information to the sink node board.

The self-powered equipment may be a solar cell panel.

If the amount of charge in the rechargeable battery is greater than a predetermined reference value, the sink node board may determine that there is sufficient spare power and apply power to the gateway board.

Another exemplary embodiment of the present invention provides a driving method of a gateway system. The driving method may include: providing a sink node board for collecting sensor data measured by a sensor node; providing a gateway board for receiving the sensor data from the sink node board; determining whether to apply power to the gateway board or not; and if it is determined that power is to be applied to the gateway board in the determining, applying power to the gateway board from the sink node board.

The determining may include: calculating how much spare power there is to drive the gateway board; and determining whether to apply power to the gateway board or not depending on the amount of spare power.

The determining may be performed by the sink node board.

The driving method may include: providing self-powered equipment that is able to produce electricity on its own without external constant power supply; and providing a rechargeable battery that stores the electricity produced by the self-powered equipment, wherein the amount of spare power may be calculated based on the amount of charge in the rechargeable battery, the electric power production of the self-powered equipment, and the power consumption of the sink node board.

If the power consumption of the gateway board is less than a value obtained by subtracting the power consumption of the sink node board from the electric power production of the self-powered equipment, power may be applied from the sink node board to the gateway board.

The driving method may further include, if power is applied from the sink node board to the gateway board, transmitting the sensor data from the sink node board to the gateway board.

The driving method may further include: sending a request for an extension of the driving time of the gateway board from the gateway board to the sink node board; and upon receiving acceptance of the extension of the driving time, transmitting the sensor data to the server.

The self-powered equipment may be a solar cell panel.

According to an embodiment of the present invention, the sink node board can build a sensor network with low power by managing the power supply of the entire gateway system.

### BRIEF DESCRIPTION OF THE DRAWINGS

FIG. 1 is a view showing the configuration of a sensor network according to an exemplary embodiment of the present invention.

FIG. 2 is a view showing the configuration of a gateway system according to the exemplary embodiment of the present invention.

FIG. 3 is a view showing the internal configuration of the built-in gateway board according to the exemplary embodiment of the present invention.

FIG. 4 is a view showing the internal configuration of the sink node board according to the exemplary embodiment of the present invention.

FIG. 5 is a view showing a method for the sink node board to control the power to the built-in gateway board according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

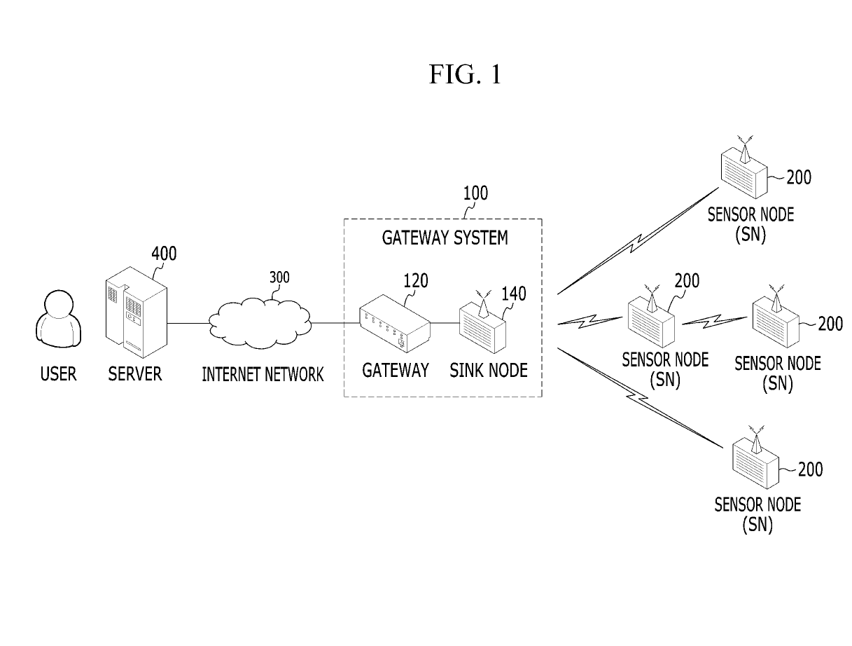

FIG. 1 is a view showing the configuration of a sensor network according to an exemplary embodiment of the present invention.

As shown in FIG. 1, the sensor network according to the exemplary embodiment of the present invention includes a gateway system 100, a plurality of sensor nodes 200, an internet network 300, and a server 400.

The sensor nodes 200 are installed in different places where measurements are made, and measure and monitor various kinds of surroundings information, and sensor data measured by the sensor nodes 200 are collected by a sink node 140 via wireless communication. The sink node 140 forwards the collected sensor data to a gateway 120, and the gateway 120 transmits the sensor data to the server 400 over the internet network 300.

In FIG. 1, the gateway 120 and sink node 140 according to the exemplary embodiment of the present invention may form a single system, i.e., the gateway system 100, though they may be separate from each other. In the gateway system 100 formed together by the gateway 120 and the sink node 140, the gateway 120 may be in the form of a built-in gateway board.

Information to be measured by the sensor nodes 200 may exist indoors or outdoors. If the sensor nodes 200 are installed outdoors, the gateway system 100 can also be installed outdoors. If the gateway system 100 is installed outdoors, constant power supply is hardly available. As such, the gateway system 100 according to the exemplary embodiment of the present invention includes self-powered equipment. Here, the self-powered equipment refers to a power supply device which supplies new and renewable energy such as sunlight, wind power, or tidal power.

The sink node 140 according to the exemplary embodiment of the present invention may only function to collect data from the sensor nodes 200, or may also function to collect surrounded environment information by having a sensor attached to it, as is the case with the sensor nodes 200. If the sink node 140 also functions to collect surrounded environment information, it may have a similar structure to the sensor nodes 200. The sensor nodes 200 can collect surrounded environment information by having a sensor mounted on them, and can have a communication interface mounted on them to communicate with the outside for the purpose of downloading programs or debugging. As the sensor nodes 200 can communicate with the gateway via the communication interface, the sensor nodes 200 can have a similar structure to the sink node 140. However, the sink node 140 includes such communication, collection, and forwarding functions in software in order to collect data from the sensor nodes 200 and forward it to the gateway 120.

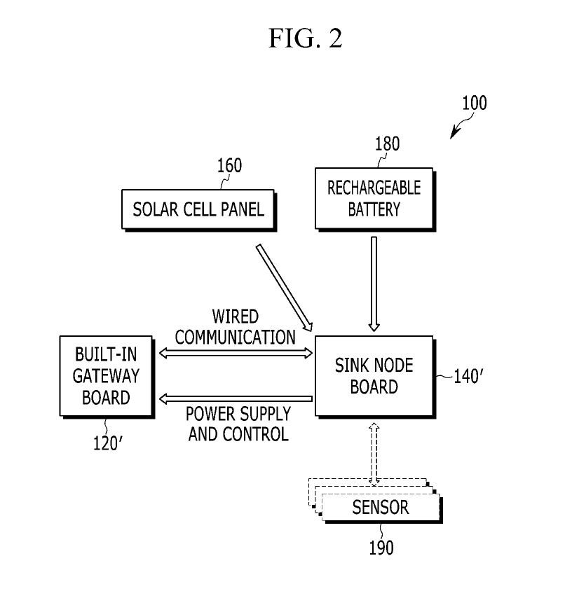

FIG. 2 is a view showing the configuration of the gateway system 100 according to the exemplary embodiment of the present invention.

As shown in FIG. 2, the gateway system 100 according to the exemplary embodiment of the present invention includes a built-in gateway board 120′, a sink node board 140′, a solar cell panel 160, a rechargeable battery 180, and a sensor 190.

In FIG. 2, the built-in gateway board 120′ corresponds to the gateway 120 of FIG. 1, and the sink node board 140′ corresponds to the sink node 140 of FIG. 1. The gateway 120 may be configured as a built-in gateway board 120′ which is embedded to serve as the gateway. Also, the sink node 140 may be connected to self-powered equipment, such as the solar cell panel 160, and to the rechargeable battery 180, and may be configured using a sensor node board having a communication function. An external sensor 190 may be attached to the sink node 140′.

If a sensor 190 is attached to the sink node board 140′ to enable the gateway system 100 to perform multiple functions, the gateway system 100 may perform a unique function using a sensor, like the sensor nodes 200 do. If sensor information is required from only one place, the gateway system 100 alone is enough to configure a single sensor network, without establishing a wireless connection to the sensor nodes 200.

The gateway system 100 includes self-powered equipment which uses new and renewable energy such as sunlight, wind power, or tidal power in order to provide a sensor network at places where constant power supply is hardly available. Although FIG. 2 only illustrates a solar cell panel as self-powered equipment for convenience of explanation, it goes without saying that the solar cell panel can be replaced with other self-powered equipment. As sunlight is used for electric power production only in the daytime, the rechargeable battery 180 for storing the electricity produced from the sunlight is included in the gateway system 100.

In the gateway system 100 according to the exemplary embodiment of the present invention, self-powered equipment (e.g., the solar cell panel 160) and the rechargeable battery 180 are connected to the sink node 140′, and the sink node board 140′ controls and supplies the power to the built-in gateway 120′. That is, the sink node board 140′ controls and supplies the power to the built-in gateway board 120′ by analyzing the electric power production of the solar cell panel 160 and predicting the power usage of the sink node board 140′ and the built-in gateway board 120′.

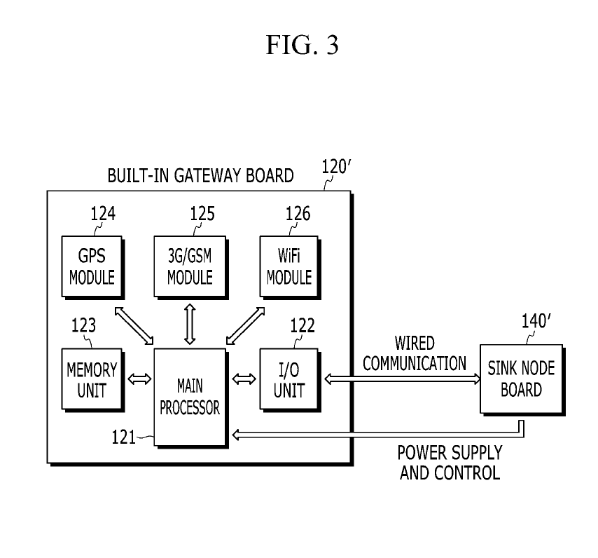

FIG. 3 is a view showing the internal configuration of the built-in gateway board 120′ according to the exemplary embodiment of the present invention.

As shown in FIG. 3, the built-in gateway board 120′ according to the exemplary embodiment of the present invention includes a main processor 121, an input/output unit 122, a memory unit 123, a GPS module 124, a 3G/GSM module 125, and a WiFi module 126.

The main processor 121 controls the overall operation of the built-in gateway board 120′, and the input/output unit 122 is an interface that transmits and receives data to and from the sink node board 140′. The input/output unit 122 may be implemented by serial I/O, parallel I/O, or wireless communication in order to transmit and receive data. The memory unit 123 temporarily stores transmitted and received data.

The built-in gateway board 120′ includes an internet accessible communication module which can access the internet to forward data to the externally installed server 400 via the internet network 300. FIG. 3 illustrates examples of communication modules, including the 3G/GSM module 125 for connection to a wireless carrier's network and the WiFi module 126 configured on a wireless LAN. Although FIG. 3 illustrates two types of wireless communication modules, wireless communication modules for satellite communication, CDMA, or 4G/LTE and communication modules with relevant functions for use in a wired internet network connection may be used.

As shown in FIG. 3, if the built-in gateway board 120′ includes the GPS module 124, the installation position of the gateway system 100 and accurate current time information thereof can be obtained. The positional information is used to notify the server 400 about the position of the sensor network (i.e., gateway system 100), and the time information may be forwarded to the sensor nodes 200 and the sink node 140 and used to accurately record the time of sensor measurement and predict electricity demand and supply.

According to the exemplary embodiment of the present invention, whether to supply power to the built-in gateway board 120′ or not is determined by the sink node board 140′. Accordingly, as shown in FIG. 3, the sink node board 140′ and the built-in gateway board 120′ are connected through a power line in the gateway system 100 according to the exemplary embodiment of the present invention, and power is supplied from the sink node 140′ to the built-in gateway board 120′ through this power line. In addition, the sink node board 140′ and the gateway board 120′ are connected through wired communication, and the sink node board 140′ forwards data collected from the sensor nodes 200 to the gateway board 120′ through wired communication. Moreover, status information and request/response messages are exchanged between the sink node board 140′ and the gateway board 120′ using a predefined protocol.

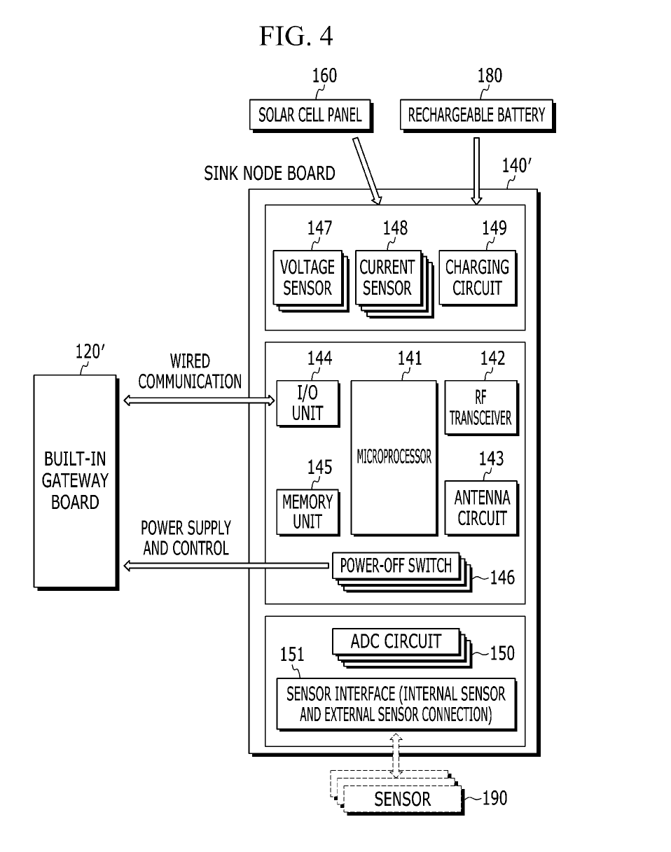

FIG. 4 is a view showing the internal configuration of the sink node board 140′ according to the exemplary embodiment of the present invention.

As shown in FIG. 4, the sink node board 140′ according to the exemplary embodiment of the present invention includes a microprocessor 141, a RF (Radio Frequency) transceiver 142, an antenna circuit 143, an input/output unit 144, a memory unit 145, a power-off switch 146, a voltage sensor 147, a current sensor 148, a charging circuit 149, an ADC circuit 150, and a sensor interface 151.

The microprocessor 141 controls the overall operation of the sink node board 140′, and the RF transceiver 142 and the antenna circuit 143 perform wireless communication with the sensor nodes 200. The input/output unit 144 performs communication with the built-in gateway board 120′, and may be implemented by serial I/O, parallel I/O, or wireless communication in order to transmit and receive data. The memory unit 145 temporarily stores transmitted and received data. If there is not enough power to drive the built-in gateway board 120′, data collected from the sensor nodes 200 to the sink node board 140′ can be stored for a long period of time in the memory unit 145.

The charging circuit 149 serves to charge the rechargeable battery 180 with solar energy supplied from the solar cell panel 160.

If a sensor 190 is attached to the sink node board 140′, the sink node board 140′ includes the sensor interface 151 for communication with the sensor 190. Also, if the sensor 190 is an analog sensor, the sink node board 140′ may include an ADC (analog to digital converter) circuit.

As shown in FIG. 4, the sink node board 140′ according to the exemplary embodiment of the present invention includes the power-off switch 146, the voltage sensor 147, and the current sensor 148. The power-off switch 146 turns the power to the built-in gateway board 120′ on and off, and turns the power to the sensor 190, the sensor interface 151, and the ADC circuit 150 on and off. The power-off switch 146 may be implemented as a relay switch or a semiconductor switching element.

The microprocessor 141 and the RF transceiver 142 can switch to sleep mode via an external pin or internal circuit, in order to reduce power consumption. That is, the microprocessor 141 may have a function for switching to sleep mode on its own, and the RF transceiver 142 may switch to sleep mode via an external pin. If the microprocessor 141 and the RF transceiver 142 do not include the function for switching to sleep mode on its own, the sleep mode function can be implemented thorough the power-off switch 146. If necessary, a timer circuit, etc. may be added.

The voltage sensor 147 measures the output voltage of the solar cell panel 160 and the output voltage of the rechargeable battery 180. The current sensor 148 measures the output current of the solar cell panel 160 and the output current of the rechargeable battery 180. Using the voltage sensor 147 and the current sensor 148, the amount of power produced from the solar cell panel 160 and the amount of power consumed by the rechargeable battery 180 can be determined in real time. Meanwhile, to analyze the power consumed by the sensor 190, the sink node board 140′ may further include the current sensor 148 that measures the output current that goes to the sensor interface 151.

The sink node board 140′ according to the exemplary embodiment of the present invention operates in low-power mode. The microprocessor 141 of the sink node board 140′ wakes up from sleep mode every predefined period of time and checks whether communication or sensor operation is required, performs the required operation, and then goes back to sleep mode.

As explained above, the sink node board 140′ according to the exemplary embodiment of the present invention controls and manages the power supplied to the built-in gateway board 120′. That is, the built-in gateway board 120′ does not act as a master to control and manage the power, but the sink node board 140′ acts as a master to control and manage the power to the built-in gateway board 120′ as if the gateway board 120′ is a kind of module.

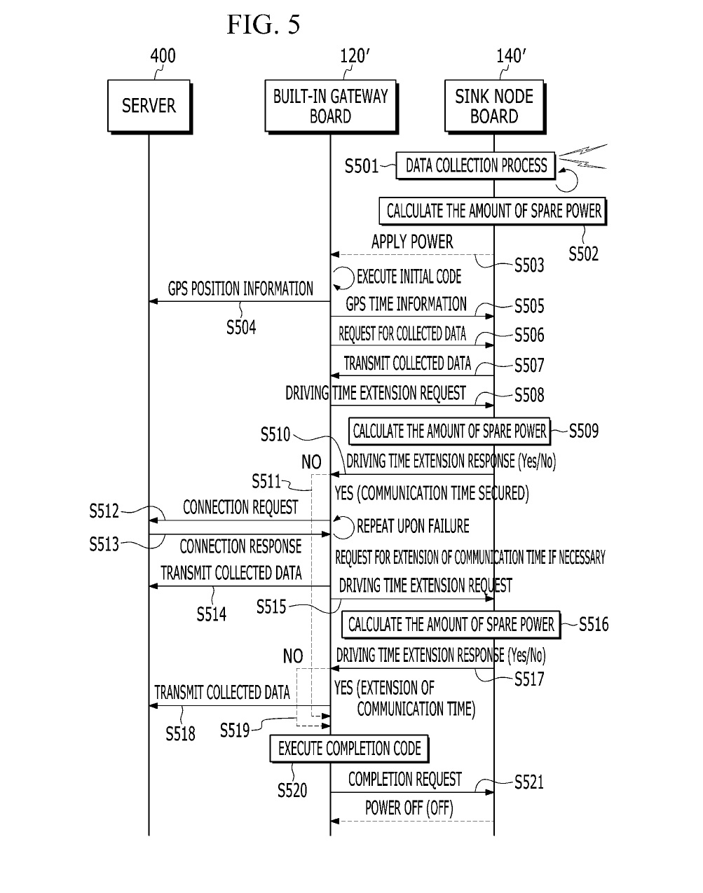

Referring to FIG. 5, a method for the sink node board 140′ to control and manage the power to the built-in gateway board 120′ will be described below.

FIG. 5 is a view showing a method for the sink node board 140′ to control the power to the built-in board 120′ according to the exemplary embodiment of the present invention.

In FIG. 5, communication protocols between the components are indicated by solid lines, and power supply and control are indicated by dotted lines.

First, the sink node board 140′ receives and collects sensor data from the sensor 190 attached to it or the sensor nodes 200 (S501). Such a data collection process is carried out by the sink node board 140′, periodically or upon detecting a communication request from the sensor nodes 200. That is, in order to achieve a low-power operation, the microprocessor 141 and RF transceiver of the sink node board 140′ are in sleep mode, which is a power-saving feature, and then wake up from sleep mode and collect data, periodically or in response to a communication request from the sensor nodes 200. The collected data is stored in the memory unit 145 of the sink node board 140′.

After carrying out the data collection process, the sink node board 140′ calculates how much spare power it has to drive the gateway board 120′, if the amount of collected data exceeds a predetermined reference value or a given period of time has elapsed (S502). Here, the amount of spare power is calculated based on the amount of charge in the rechargeable battery 180, the electric power production of the solar cell panel 160, and the power consumption of the sink node board 140′. The amount of charge in the rechargeable battery 180 is calculated based on the output voltage of the rechargeable battery 180 measured by the voltage sensor 147, and the electric power production of the solar cell panel 160 is calculated based on the output voltage of the solar cell panel 160 measured by the voltage sensor 147 and the output current of the solar cell panel 160 measured by the current sensor 148. The power consumption of the sink node board 140′ is calculated based on the output voltage of the rechargeable battery 180 measured by the voltage sensor 147 and the output current of the rechargeable battery 180 measured by the current sensor 148. If the amount of charge in the rechargeable battery 180 is sufficient and Equation 1 below is satisfied, the sink node board 140′ deems the built-in gateway board 120′ as drivable. Whether the amount of charge in the rechargeable battery 180 is sufficient or not can be determined properly through a test process.

Power consumption of built-in gateway board<(electric power production of solar cell panel−power consumption of sink node board) (Equation 1)

When one of the two conditions is satisfied, as well as when the above-mentioned two conditions are satisfied (i.e., the amount of charge in the rechargeable battery 180 is sufficient and Equation 1 is satisfied), it is determined that there is enough power to spare.

If it is determined that there is not enough power to spare to drive the built-in gateway board 120′ in S502, the sink node board 140′ continues to repeat the data collection process (S501).

If it is determined that there is enough power to spare to drive the built-in gateway board 120′ in S502, the sink node board 140′ applies power to the built-in gateway board 120′ (S503). When power is applied to the sink node board 140′, the built-in gateway board 120′ runs the operating system and executes an initial code.

If the built-in gateway board 120′ includes the GPS module 124, when the GPS module 124 of the built-in gateway board 120′ operates, the installation position (GPS position information) and current time information (GPS time information) of the built-in gateway board 120′ are acquired. The acquired GPS position information is transmitted to the server 400, and the GPS time information is transmitted to the sink node board 140′. The GPS time information transmitted to the sink node board 140′ is used to analyze the power of the sink node board 140′ and correct the sensing time of the sensor nodes 200.

Next, the built-in gateway board 120′ sends to the sink node board 140′ a request for data collected in the data collection process S501 (S506).

Having received the request, the sink node board 140′ transmits to the built-in gateway board 120′ data stored in the memory unit 145 during the data collection process S501 (S507). The sink node board 140′ may transmit data to the built-in gateway board 120′ several times depending on the amount of collected data.

Meanwhile, the power the built-in gateway board 120′ has consumed until this step S507 is used as data for determining whether the sink node board 140′ will drive the built-in gateway board 120′ or not (i.e., calculating how much spare power it has in S502).

Accordingly, before the built-in gateway board 120′ transmits data to the server 400, the built-in gateway board 120′ sends a request to the sink node board 140′ for extending the driving time of the built-in gateway board 120′, along with the expected time required for internet network connection (S508).

The sink node board 140′ decides, as shown in the equation in S502, if it has enough spare power with respect to the power consumption of the built-in gateway board 120′ which corresponds to the expected time transmitted from the gateway board 120′ (S509). The sink node board 140′ transmits a Yes response to the built-in gateway board 120′ if it has enough spare power, or transmits a No response to the built-in gateway board 120′ if it does not have enough spare power (S510).

If the built-in gateway board 120′ receives a No response, a completion code execution step is performed (S511). On the other hand, if the built-in gateway board 120′ receives a Yes response, communication time is secured and a connection request is sent to the server 400 through a communication module 125, 126, etc. (S512). The built-in gateway board 120′ may repeat the above procedure several times until it receives a normal response (S513) from the server 400. Upon failing to receive a normal connection response from the server 400, the built-in gateway board 120′ enters the completion code execution step, or upon receiving a normal connection response, it executes the following step S514.

In S514, the built-in gateway board 120′ transmits data collected from the sink node board 140′ to the server 400. The step S514 may be performed several times depending on the amount of collected data.

If it takes more time than expected for the built-in gateway board 120′ to transmit data, because more time is spent on the connection request and response in S512 to S514, the communication time secured in S508 to S510 will not be sufficient. In case of lack of communication time, the built-in gateway board 120′ sends a driving time extension request (request for an extension of the communication time with the server) to the sink node board 140′ (S515), and the sink node board 140′ calculates how much spare power it has and transmits a driving time extension response (Yes or No) to the built-in gateway board 120′ (S516 and S517).

Upon receiving Yes as a driving time extension response from the sink node board 140′, i.e., upon succeeding in extending the communication time with the server, the built-in gateway board 120′ continues to transmit collected data to the server 400 (S518). On the other hand, upon receiving No as a driving time extension response from the sink node board 140′, i.e., upon failing to extend the time of communication with the server, the built-in gateway board 120′ enters the completion code execution step (S520). To extend the communication time, it takes another time for the operating system of the built-in gateway board 120′ to execute the completion code, and therefore the request for an extension of the communication time is submitted in consideration of completion code execution time.

Finally, the built-in gateway board 120′ performs the completion code execution step (S520). The completion code execution step is performed when all data is normally transmitted to the server 400, when initial communication time with the server is not secured unlike in S511, or when the communication time with the server is not extended unlike in S519. To prevent missing data in the next driving operation, the current state of completion of the communication with the server 400 is recorded in the completion code.

When the completion code is fully executed, the built-in gateway board 120′ sends a completion request to the sink node board 140′ (S521). Having received the completion request, the sink node board 140′ turns off the power to the built-in gateway board 120′.

In this way, according to the exemplary embodiment of the present invention, the sink node board 140′ can manage the power of the entire gateway system 100 and operate the gateway system 100 only with the use of a small solar cell panel. As a consequence, spatial restrictions on the installation of a sensor network can be overcome, and the sensor network can be built across a wide area.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A gateway system comprising:
a sink node board that collects sensor data measured by a sensor node and transmits the sensor data; and
a gateway board that transmits the sensor data transmitted from the sink node board to a server,
wherein the sink node board controls whether to apply power to the gateway board or not.

2. The gateway system of claim 1, wherein the sink node board calculates how much spare power there is to drive the gateway board, and determines whether to apply power or not depending on the amount of spare power.

3. The gateway system of claim 2, further comprising:
self-powered equipment that is connected to the sink node board and that is able to produce electricity on its own without external constant power supply; and
a rechargeable battery that is connected to the sink node board and stores the electricity produced by the self-powered equipment,
wherein the sink node board calculates the amount of spare power based on the amount of charge in the rechargeable battery, the electric power production of the solar cell panel, and the power consumption of the sink node board.

4. The gateway system of claim 3, wherein, if the power consumption of the gateway board is less than a value obtained by subtracting the power consumption of the sink node board from the electric power production of the self-powered equipment, the sink node board determines that there is sufficient spare power and applies power to the gateway board.

5. The gateway system of claim 2, wherein, if the sink node board applies power to the gateway board, the sink node board transmits the sensor data to the gateway board.

6. The gateway system of claim 5, wherein,
upon receiving the sensor data from the sink node board, the gateway board sends a request for an extension of the driving time of the gateway board to the sink node board, and
upon receiving acceptance of the extension of the driving time from the sink node board, may transmit the sensor data to the server.

7. The gateway system of claim 1, wherein the sink node board comprises a power-off switch for switching the power on or off.

8. The gateway system of claim 1, wherein
the gateway board comprises a GPS module that acquires the gateway board's position information and current time information, and
the gateway board transmits the position information to the server and the current time information to the sink node board.

9. The gateway system of claim 3, wherein the self-powered equipment is a solar cell panel.

10. The gateway system of claim 4, wherein, if the amount of charge in the rechargeable battery is greater than a predetermined reference value, the sink node board determines that there is sufficient spare power and applies power to the gateway board.

11. The gateway system of claim 1, further comprising:
a sensor to be attached to the sink node board,
the sink node board comprising a sensor interface for communication with the sensor,
wherein the sink node board collects and transmits sensor data measured by the sensor.

12. A driving method comprising:
providing a sink node board for collecting sensor data measured by a sensor node;
providing a gateway board for receiving the sensor data from the sink node board;
determining whether to apply power to the gateway board or not; and
if it is determined that power is to be applied to the gateway board in the determining, applying power to the gateway board from the sink node board.

13. The method of claim 12, wherein
the determining comprises:
calculating how much spare power there is to drive the gateway board; and
determining whether to apply power to the gateway board or not depending on the amount of spare power.

14. The method of claim 12, wherein the determining is performed by the sink node board.

15. The method of claim 13, further comprising:
providing self-powered equipment that is able to produce electricity on its own without external constant power supply; and
providing a rechargeable battery that stores the electricity produced by the self-powered equipment,
wherein the amount of spare power is calculated based on the amount of charge in the rechargeable battery, the electric power production of the self-powered equipment, and the power consumption of the sink node board.

16. The method of claim 15, wherein, if the power consumption of the gateway board is less than a value obtained by subtracting the power consumption of the sink node board from the electric power production of the self-powered equipment, power is applied from the sink node board to the gateway board.

17. The method of claim 12, further comprising,
if power is applied from the sink node board to the gateway board, transmitting the sensor data from the sink node board to the gateway board.

18. The method of claim 17, further comprising:
sending a request for an extension of the driving time of the gateway board from the gateway board to the sink node board; and
upon receiving acceptance of the extension of the driving time, transmitting the sensor data to the server.

19. The method of claim 15, wherein the self-powered equipment is a solar cell panel.
